(19) United States
(12) Patent Application Publication
(10) Pub. No.: US 2017/0004120 A1
(43) Pub. Date: Jan. 5, 2017

(54) CORRECTIONS FOR NATURAL LANGUAGE PROCESSING

(71) Applicant: Facebook, Inc., Menlo Park, CA (US)

(72) Inventors: Matthias Gerhard Eck, Mountain View, CA (US); Fei Huang, Boonton, NJ (US); Kay Rottmann, San Francisco, CA (US)

(21) Appl. No.: 14/788,578

(22) Filed: Jun. 30, 2015

(51) Int. Cl. G06F 17/24; G06F 17/28; G06F 17/27; G06F 17/22

(52) U.S. Cl. CPC G06F 17/24; G06F 17/2211; G06F 17/28; G06F 17/2775

(57) ABSTRACT

Technology is disclosed for correcting items containing natural language words that match qualified corrections. Qualified corrections can be identified from language snippet sets, which can include, for example, a post to a social media website and one or more updates to that post. Qualified corrections can be word pairs identified in one of these language snippet sets by aligning words between the language snippets according to a minimum word edit distance and computing that the word edit distance is below a first threshold. Based on this word alignment, word pairs can be selected and analyzed to identify qualified corrections as the word pairs that have a minimum character edit distance below a second threshold. In some cases, such as where both words in the qualified correction word pair are known words, a context can be associated with the qualified correction to control when the qualified correction should be applied.

### BACKGROUND

The Internet has made it possible for people to connect and share information globally in ways previously undreamt of. Social media platforms, for example, enable people on opposite sides of the world to collaborate on ideas, discuss current events, or simply share what they had for lunch. The amount of content generated through social media technologies is staggering. It is common for social media providers to operate databases with petabytes of media items, while leading providers are already looking toward technology to handle exabytes of data. Media items at least partially containing natural language (“language snippets”) are subject to some human error. While at times language snippet authors correct these errors as they enter them, often these errors are only identified by an automated system or remain uncorrected.

Errors have been a particularly prevalent problem for machine translations of language snippets. Machine translation engines enable a user to select or provide a source content item (e.g., a message from an acquaintance) in one natural language (e.g., Spanish) and quickly receive a translation of the content item in a different natural language (e.g., English). Machine translation engines can be created using training data that includes identical or similar content in two or more languages. However, the effectiveness of these machine translation engines can be significantly reduced when the source content item contains errors.

### BRIEF DESCRIPTION OF THE DRAWINGS

FIG. 1 is a block diagram illustrating an overview of devices on which some implementations of the disclosed technology can operate.

FIG. 2 is a block diagram illustrating an overview of an environment in which some implementations of the disclosed technology can operate.

FIG. 3 is a block diagram illustrating components which, in some implementations, can be used in a system employing the disclosed technology.

FIG. 4 is a flow diagram illustrating a process used in some implementations for identifying corrections from sets of language snippets.

FIG. 5A is a flow diagram illustrating a process used in some implementations for comparing language snippets within a set of language snippets to identify corrections.

FIG. 5B is an example illustrating the process of FIG. 5A for comparing language snippets within a set of language snippets to identify corrections.

FIG. 6 is a flow diagram illustrating a process used in some implementations for modifying a language snippet using correction replacements.

The techniques introduced here may be better understood by referring to the following Detailed Description in conjunction with the accompanying drawings, in which like reference numerals indicate identical or functionally similar elements.

### DETAILED DESCRIPTION

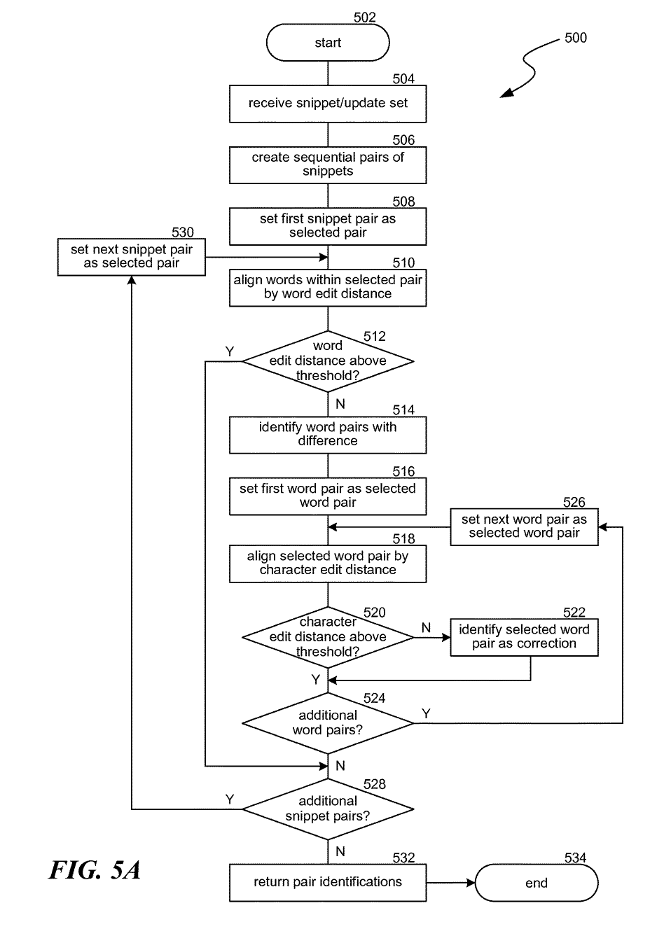

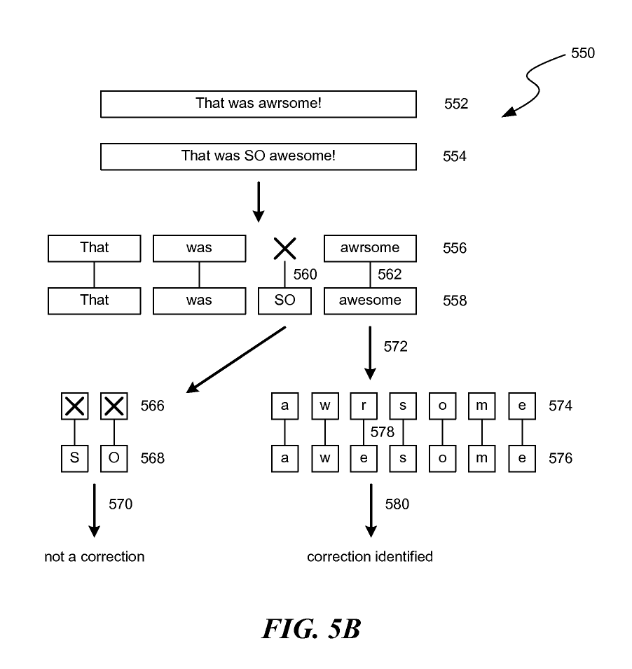

A natural language correction system is disclosed that generates correction modules by identifying corrections in language snippets and uses the correction modules to automatically correct other language snippets. As used herein, a “language snippet” is a digital representation of one or more words. A “correction module” can analyze a language snippet and replace words or segments identified as errors with corresponding identified revision (i.e. a correction). The natural language correction system can identify corrections across a set of language snippets by computing that a minimum word edit distance between the language snippets is below a first threshold and a that a minimum character edit distance for individual word pairs is below a second threshold. An “edit distance” between language snippets, as used herein, is a number of changes used to change a first of the language snippets into a second of the language snippets. The natural language correction system can create word pairs by aligning words between two language snippets according to a minimum word edit distance. The words within the word pairs can then be compared to identify, as qualified corrections, the word pairs that have a minimum character edit distance that is below a character difference threshold. Examples of identifying qualified corrections are provided below, such as in relation to FIG. 5B.

In some implementations, a context of one or more of the corrections is associated with the identified corrections which is later used to determine when the correction should be applied, e.g. when the later context matches the context associated with the correction. The natural language correction system can, in some implementations, associate a context with a correction when the corrected word is a real word in a given language.

In various implementations, the natural language correction system can train the correction modules with spelling, grammar, punctuation, or phrasing corrections, and can employ them in an auto-correction or suggestion function of a language input module or as an initial stage of performing a machine translation. For example, the word pairs with a minimum character edit distance below a threshold can indicate a spelling or punctuation correction. After a correction, such as “likr”->“like,” has been identified a threshold number of times, the natural language correction system can add the correction to a correction module. Subsequent observations of a user entering “likr” can automatically be changed to “like,” or “like” can be suggested to the user as a change.

As another example, a correction module that has been trained with the “likr”->“like” correction can be used during a machine translation of the language snippet “I really likr your painting.” The “likr” word will not have a direct translation, which can result in the translation including the untranslated word or an incorrect translation. This can make the translation difficult to understand and frustrating for viewers. To prevent this, the natural language correction system can perform an initial step in the machine translation process to make corrections to the language snippet prior to translating it. For example, in a process to translate the original language snippet of “I really likr your painting” into Spanish, the translation process can create an intermediate corrected language snippet “I really like your painting,” which the machine translation process can then translate into “Me gusto mucho to pintura.” In various implementations, the intermediate corrected language snippet does or does not also replace the original language snippet.

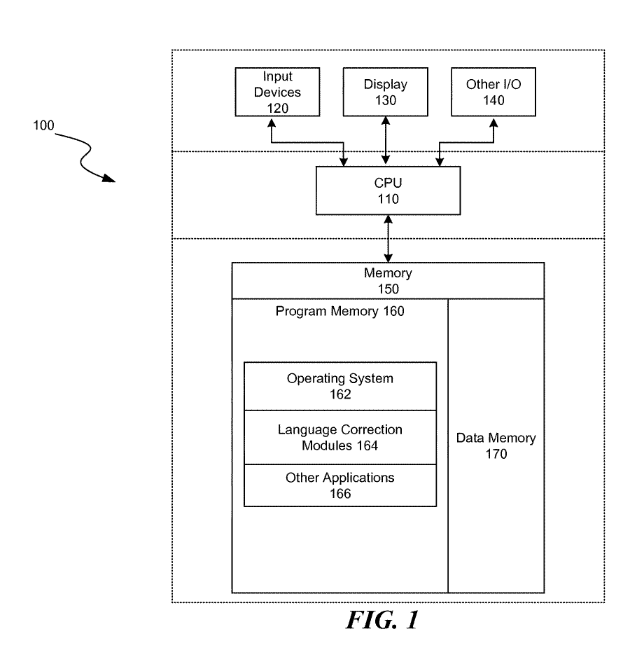

Several implementations of the described technology are discussed below in more detail in reference to the figures. Turning now to the figures, FIG. 1 is a block diagram illustrating an overview of devices 100 on which some implementations of the disclosed technology may operate. The devices can comprise hardware components of a device 100 that generates or implements language snippet correction modules. Device 100 can include one or more input devices 120 that provide input to the CPU (processor) 110, notifying it of actions. The actions are typically mediated by a hardware controller that interprets the signals received from the input device and communicates the information to the CPU 110 using a communication protocol. Input devices 120 include, for example, a mouse, a keyboard, a touchscreen, an infrared sensor, a touchpad, a wearable input device, a camera- or image-based input device, a microphone, or other user input devices.

CPU 110 can be a single processing unit or multiple processing units in a device or distributed across multiple devices. CPU 110 can be coupled to other hardware devices, for example, with the use of a bus, such as a PCI bus or SCSI bus. The CPU 110 can communicate with a hardware controller for devices, such as for a display 130. Display 130 can be used to display text and graphics. In some examples, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The CPU 110 has access to a memory 150. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 150 includes program memory 160 that stores programs and software, such as an operating system 162, language correction modules 164, and any other application programs 166. Memory 150 also includes data memory 170 that can include, for example, language snippets, identified corrections, contexts associated with identified corrections, edit distance algorithm rules, dictionaries, threshold values, configuration data, settings, and user options or preferences which can be provided to the program memory 160 or any element of the device 100.

The disclosed technology is operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, tablet devices, multiprocessor systems, microprocessor-based systems, set-top boxes, programmable consumer electronics, network PCs, minicomputers, mainframe computers, distributed computing environments that include any of the above systems or devices, and the like.

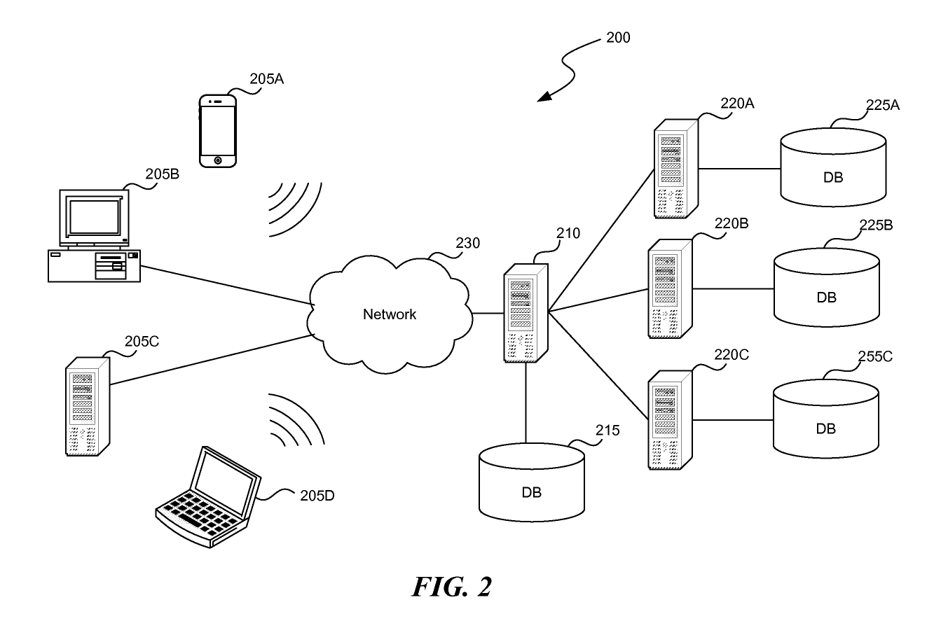

FIG. 2 is a block diagram illustrating an overview of an environment 200 in which some implementations of the disclosed technology may operate. Environment 200 can include one or more client computing devices 205A-D, examples of which may include device 100. Client computing devices 205 can operate in a networked environment using logical connections 210, through network 230, to one or more remote computers such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 may correspond to a group of servers, and each of these servers can share a database or can have their own database. Databases 215 and 225 can warehouse (e.g. store) information such as sets of a language snippet with updates, identified corrections, contexts associated with identified corrections, dictionaries for various languages, etc. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. The client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

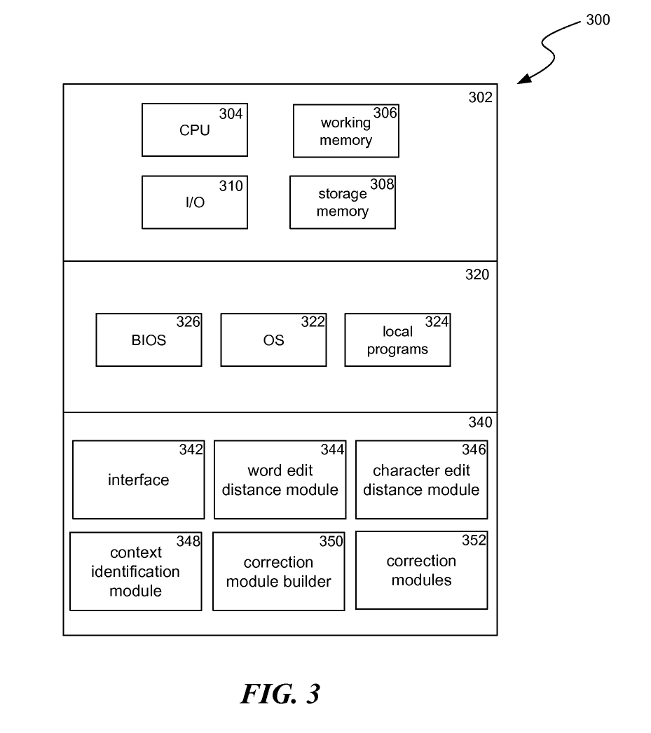

FIG. 3 is a block diagram illustrating components 300 that, in some implementations, can be used in a system implementing the disclosed technology. The components 300 include hardware 302, general software 320, and specialized components 340. As discussed above, a system implementing the disclosed technology can use various hardware including central processing units 304, working memory 306, storage memory 308, and input and output devices 310. Components 300 can be implemented in a client computing device such as client computing devices 205 or on a server computing device, such as server computing device 210 or 220.

General software 320 can include various applications including an operating system 322, local programs 324, and a BIOS 326. Specialized components 340 can be subcomponents of a general software application 320, such as a local program 324. Specialized components 340 can include word edit distance module 344, character edit distance modules 346, context identification module 348, correction module builder 350, correction modules 352, and components which can be used for controlling and receiving data from the specialized components, such as interface 342.

Word edit distance module 344 can receive a set of two or more language snippets through interface 342. In some implementations, the language snippets within each set can be ordered, indicating that a later language snippet in the order is a correction to an earlier language snippet in the order. For each possible pair of language snippets among the received set, the words between the pair of language snippets can be aligned such that the alignment corresponds to a minimum word edit distance. As used herein, a “word edit distance” refers to a number of word additions, word removals, or word substitutions used to transform one language snippet into another language snippet. For example, between the language snippets: “I went to the movidess,” and “I went to the movies,” requires the single change of “movidess” to “movies,” so even though there are two typographical errors in movidess, the minimum edit distance would be one. As another example, between the language snippets: “Best thai food!” and “Best Thai food EVER!” requires the two changes “thai” to “Thai” and adding “EVER,” so the minimum edit distance would be two. In various implementations, punctuation or capitalization can be ignored when computing edit distances. In some implementations where the received sets include snippet orderings, the edit distances can be determined for changing the earlier language snippet into the later language snippet.

Word edit distance module 344 can also select language snippet pairs with a minimum edit distance below a threshold. For example, the threshold can be two, three, or five differences. In some implementations, the threshold can be scaled based on the length of the language snippets. For example, a word edit distance threshold can indicate that pairs should be selected where the ratio of the minimum word edit distance to the number of words in one of the language snippets is less than 1:4. In some implementations, the ratio can be dependent on the length of the language snippet to avoid removing all corrections where the language snippet is below a certain word length. For example, where the language snippet only contains three words, the word edit distance threshold ratio can be raised to 1:3. Selecting language snippet pairs based on a minimum word edit distance is discussed in more detail below in relation to FIG. 5, elements 506-512.

Character edit distance modules 346 can, for each word pair determined according to the alignment found by word edit distance module 344, compute a minimum character edit difference. A character edit difference, as used herein, refers to a number of character additions, removals, or substitutions required to transform a first word into a second word. For example, to change the word “movidess” to “movies” the “d” and extra “s” can be removed, which is a character edit distance of two. Although there may be many ways to transform one word or n-gram into another, there will always be one minimum edit distance, which will be equal to, or less than, the length of the longer word or n-gram in the pair. Character edit distance modules 346 can also select word pairs that have a character edit distance below a threshold level. In various implementations, the character edit distance threshold can be two, three, or five differences. Similar to the threshold for the word edits distances, the threshold can be scaled based on the length of the words in the pair and can be modified based on the word length. In some implementations where the received sets include snippet orderings, the edit distances can be determined for changing the word from the earlier language snippet into the word from the later language snippet. Selecting word pairs based on a minimum character edit distance is discussed in more detail below in relation to FIG. 5, elements 514-526.

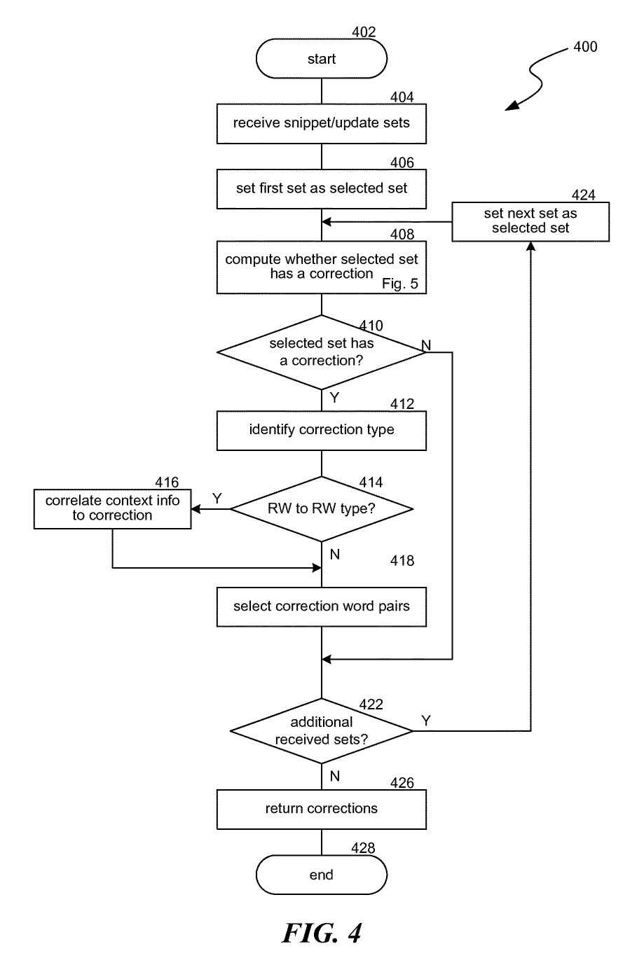

Context identification module 348 can receive word pairs selected by character edit distance modules 346 and select word pairs where both words in the pair are known words in a particular language, such as where a word pair consists of “ore” and “more.” In some implementations where there is an order defined between the word pairs, context identification module 348 can also select word pairs where the earlier word in the pair is a known word but the later word is not, such as “dog”->“dawg.” Context identification module 348 can associate a context with the selected word pairs. A context can be a number of words surrounding (before, after, or both) the word in one of the language snippets. Where the language snippet has an order, the context is taken from the earlier language snippet of the pair. In some implementations, the context can include other features of one or both of the language snippets such as other content items or links associated with the language snippet, a location or location type where the language snippet is posted or used, one or more identified characteristics of the language snippet author (e.g. location, age, gender, ethnicity, profession, income, friend group, etc.), or a geographic location associated with the language snippet. In various implementations, contexts may or may not be associated with word pairs where both words or the earlier word in the order is not identified as a word in a known language. Identifying a context for a word pair is discussed in more detail below in relation to FIG. 4, elements 412-416.

Correction module builder 350 can receive word pairs selected by character edit distance modules 346, either with or without a context, and use them to build a correction module. Resulting correction modules can include mappings of words to word replacements. In some implementations, the mappings are only created once a threshold number or percentage of a particular selection is identified. For example, a word pair can be used for a mapping once it has been identified at least 1,000 times. As another example, a word pair can be used for a mapping if at least 10% of the times that the earlier word is used it is corrected. As yet a further example, a word pair can be used for a mapping if at least 60% of the times that the earlier word is corrected, it is corrected to the later word. In some implementations, a mapping can be associated with a context for determining when to apply the mapping.

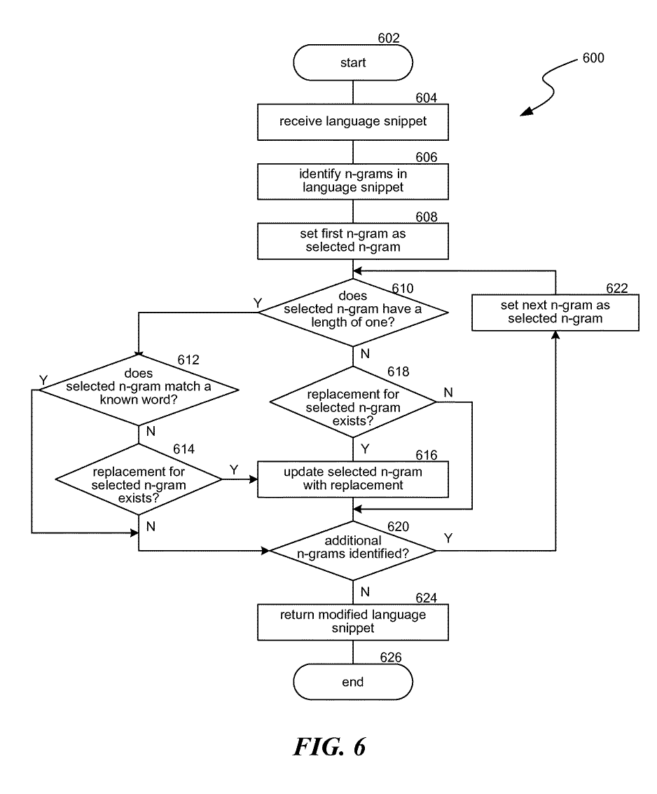

Correction modules 352, built by correction module builder 350, can be used in the same computing system as components 344-350, or can be transferred to other computing systems for independent use. Correction modules can be used to generate a corrected language snippet for a given language snippet. This can be accomplished by determining if any n-gram of the given language snippet matches a mapping included in a correction module. The matching can include determining for single-word n-grams whether the word is a known word, and if not, determining if a word pair including the n-gram is included in the correction module. The matching can also include determining whether a context included in the correction module corresponds to a multiple-word n-gram of the give language snippet, and if so, making a word replacement according to a word pair associated in the correction module with the corresponding context. In some implementations, additional conditions can be compared to determine if a mapping of the correction module should be applied. For example, a mapping can be associated with a context such as other content items or links, a location or location type, one or more identified author characteristics (e.g. location, age, gender, ethnicity, profession, income, friend group, etc.), or a geographic location. Mappings with these types of contexts can be configured to be employed where the given language snippet is associate with a sufficiently similar context. Using correction modules to obtain a modified language snippet is discussed in more detail below in relation to FIG. 6.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc.

FIG. 4 is a flow diagram illustrating a process 400 used in some implementations for identifying corrections from sets of language snippets. Process 400 begins at block 402. At block 404 one or more sets of language snippets can be received. In some implementations, the language snippets included in one or more of the received language snippet sets can be ordered according to which language snippet is an update, correction, or modification of the previous language snippet. In various implementations, the language snippet sets can be obtained from a post to a social media website and subsequent updates to that post, a sequence of similar queries made by the same user within a timeframe, or sequential versions of websites, such as recorded editions of a wiki-type website. Each set of language snippets can include at least two language snippets. In some implementations, one or more of the sets can include more than two language snippets, such as where a social media user makes multiple updates to the same post.

In some implementations, a machine translation engine can generate multiple versions of a content item and the various versions can be scored. A set of language snippets can be selected where the higher score versions can be considered modifications to the lower scored versions. Additional details on machine translation engines generating multiple versions of a content item and the various versions being scored is discussed in more detail in U.S. patent application Ser. No. 14/586,022, incorporated herein by reference.

At block 406 a first set of the received sets of language snippets is assigned as a selected set. At block 408 the selected set is analyzed to determine if the selected set has a qualified correction. Qualified corrections are those that should be corrected when similar mistakes are found, such as spelling, grammar, or punctuation mistakes. Qualified corrections can be found by aligning words between language snippets according to a minimum word edit distance and proceeding with language snippet pairs that have a minimum word edit distance below a threshold. Of these language snippet pairs, aligned words can be compared to compute a minimum character edit distance and selecting word pairs with a minimum character edit distance below a threshold. Identifying qualified corrections is discussed in more detail below in relation to FIG. 5.

At decision block 410 process 400 determines whether the selected set has one or more word pair corrections. If not, process 400 continues to block 22. If so, process 400 continues to block 412. At block 412 types for one or more word pairs identified at block 408 can be determined. The types can be based on whether either or both of the words in the word pair are known words. In various implementations, the types can correspond to the pairs relating as one of: a real-word to real-word, unknown-word to unknown-word, real-word to unknown-word, or unknown-word to real-word (“RW to “RW”). In some implementations, the search for known words can be restricted to a single language. In some implementations, the language snippets can be pre-classified as being written in a particular language, and the search for known words can be restricted to that language. At decision block 414 process 400 makes a determination whether the word type matches real-word to real-word. In some implementations, the determination can also match for word pairs identified as a real-word to unknown-word type. These identifications and determinations for type are made so that resulting correction modules can determine when (i.e. in what context) to substitute a real word with a learned correction. For example, where a user enters the language snippet “Let's go tome,” if a correction module is trained with the word pair “tome”->“home” with the context “Let's go,” the correction module can change “tome” to “home,” even though tome is a real word. If, at decision block 414, the type for the word pair matches, process 400 continues to block 416, otherwise process 400 continues to block 418.

At block 416 a context can be correlated to the correction word pair. In some implementations, the context can be an n-gram before, after, or both before and after the word in one of the language snippets. Where the language snippets have an order indicating that a later snippet is a modification of the earlier snippet, the context can be taken from the earlier snippet in the order. In some implementations, the context can be taken from an original version of the language snippet. In some implementations where multiple corrections are found in a single language snippet, the context can be taken after applying the corrections to the surrounding n-grams. For example, where the language snippet pairs are “That mean was amazink!”->“That meal was amazing!” the context for the word pair “mean”->“meal” can be the corrected version “was amazing” instead of the original version “was amazink.”

In some cases, block 408 can identify multiple corrections in the selected set, in which case blocks 412-416 can be performed for each identified word pair correction. At block 418 the word pair corrections operated on at blocks 412-416 can be selected and added to a result set.

At decision block 422 process 400 determines whether there are additional received sets of language snippets. If so, process 400 continues to block 424 where the next set of language snippets is set as the selected set to be operated on by the loop between blocks 408 and 422. If not, process 400 continues to block 426.

At block 426 the result set, including the word pair corrections from block 418, can be returned. These word pair corrections can be used to train a correction module. The correction module can contain word pair mappings that can be used select errors in a user input and replace them with a correction. This can occur, for example, as an intermediate step to a translation, as a method of expanding the search parameters of a query, or as part of an autocorrect or correction suggestion system for user input. In some implementations, correction word pairs returned at block 426 are only included in a correction module when the same correction word pair is returned a threshold number of times. The threshold can be different for different types. For example, a higher threshold number of returned corrections can be required when the type is real-word to unknown-word than for real-word to real-word. In some implementations, the returned word pair corrections can be used as training data for a traditional classifier, such as a support vector machine or neural network. Process 400 then continues to block 428, where it ends.

FIG. 5A is a flow diagram illustrating a process 500 used in some implementations for comparing language snippets within a set of language snippets to identify corrections. Process 500 begins at block 502. At block 504 a set of language snippets is received. In some implementations, the received set of language snippets can be the selected set operated on at block 408 of FIG. 4. In some implementations, the received set of language snippets can include an order indicating first snippet and one or more subsequent snippets which are each an update to the previous snippet in the order. In some implementations, the updates can, instead of indicating an entire snippet, indicate the change made to the previous snippet.

At block 506 process 500 can create pairs of snippets. The created pairs can be all potential pairs between the snippets in the received set. For example, for snippets A, B, and C, with order A->B->C, the pairs could be AB, BC, and AC. In some implementations, the pairs can retain indications of an order between the pairs. In some implementations, the created pairs can include only those where the later language snippet is a direct update of the earlier snippet. For example, for snippets A, B, and C, with order A->B->C, the pairs could be AB and BC.

At block 508 the first pair created at block 506 is set as a selected pair. At block 510 the words between the selected pair of language snippets can be aligned such that the alignment provides a minimum word edit distance. As discussed above, this alignment occurs such that a maximum number of words that are the same are aligned and a minimum number of word additions, deletions, or changes (i.e. word edit distance) are required to change the first language snippet of the pair into the second language snippet of the pair. In some implementations, punctuation or certain types of punctuation between the language snippets can be ignored. For example, punctuation ending a sentence such as “.” “!” and “?” can be ignored, but punctuation generally included as part of a word, such as an apostrophe in a contraction or an accent mark can be included in the alignment analysis.

At decision block 512 process 500 determines whether the word edit distance is above a threshold. In various implementations, the threshold can be two, three, or five total additions, deletions, or changes. In some implementations, the threshold can be a function of the number of words in the earlier language snippet. For example, the threshold comparison can be based on a percentage found by taking the word edit distance over the total number of the words in the earlier language snippet, such as where no more than 10%, 25%, or 33% of the words are added, removed, or changed. If the minimum word edit distance is above the threshold, process 500 continues to block 528, otherwise process 500 continues to block 514.

At block 514 the selected language snippet pair is deconstructed into word pairs according to the minimum word edit distance alignment found at block 510. Where the alignment indicates a word addition or deletion, the word pairs can include a word from one language snippet for half of the pair and an indication of a blank for the other half of the word pair. In some implementations, the word pairs selected at block 514 comprise only the word pairs that correspond to a word addition, deletion, or change. In some implementations, the word pairs selected at block 514 can comprise only the word pairs that correspond to a word change. In some implementations, the word pairs can maintain an order established between their corresponding language snippets. As used herein, where an order exists between language snippets that resulted in a word pair, the earlier word in the order is referred to as the “original” word and the later word is referred to as the “update” word. At block 516 the first word pair found in block 514 is set as a selected word pair.

At block 518 the selected word pair is aligned such that the alignment provides a minimum character edit distance. As discussed above, this alignment occurs such that a maximum number of characters that are the same are aligned and a minimum number of character additions, deletions, or changes (i.e. character edit distance) are required to change the first word of the selected word pair into the second word of the selected word pair. In various implementations, punctuation generally included as part of a word, such as an apostrophe in a contraction or an accent mark, can be included or ignored in the alignment analysis.

At decision block 520 process 500 determines whether the minimum character edit distance corresponding to the alignment found at block 518 is above a character edit distance threshold. In some implementations, this character edit distance can be one, two, or three character additions, deletions, or changes. This comparison can take into account the length of one of the words in the selected word pair or the average length of the words in the selected word pair. For example, where the character edit distance is no more than twenty percent of the of the entire word, meaning that no more than twenty percent of the characters of one word of the selected word pair were added, deleted, or changed to arrive at the other word of the selected word pair, the character edit distance can be considered below the character edit distance threshold. If the character edit distance is above the character edit distance threshold process 500 continues to block 524, otherwise process 500 continues to block 522. At block 522 the selected word pair can be identified as a qualified word pair correction. This can include, for example, creating a list of qualified word pair corrections, storing a pointer to the selected word pair, or adding the selected word pair to a master list of qualified word pair corrections or, where the master list already contains the selected word pair, updating a corresponding count for the selected word pair.

At decision block 524 process 500 determines whether there are additional word pairs that were identified at block 514 and that have not been analyzed by the loop between blocks 518-526. If there are additional word pairs, process 500 continues to block 526 where the next one of these word pairs can be set as the selected word pair to be operated on by the loop between blocks 518-526. If there are no additional word pairs, process 500 continues to block 528.

At decision block 528 process 500 determines whether there are additional language snippet pairs that were identified at block 506 and that have not been analyzed by the loop between blocks 510-530. If there are additional language snippet pairs, process 500 continues to block 530 where the next one of these language snippet pairs can be set as the selected pair to be operated on by the loop between blocks 510-530. If there are no additional language snippet pairs, process 500 continues to block 532. At block 532 the word pairs identified as qualified corrections at block 522 can be returned. In various implementations, this can include providing a data structure containing the word pairs or a pointer to a data structure. In some implementations, block 522 can store data accessible outside process 500 (e.g. storing in a globally accessible variable or writing to separate database) in which case process 500 may not need to return word pairs. Process 500 then continues to block 534, where it ends.

FIG. 5B is an example 550 illustrating the process of FIG. 5A for comparing language snippets within a set of language snippets to identify corrections. Example 500 starts with two language snippets 552 and 554, these can be received corresponding to block 504. In example 550, language snippet 554 is an update of language snippet 552.

The words of language snippet 552 can be split into words 556 and aligned with the words 558 of language snippet 554, according to a minimum word edit distance, which corresponds to block 510. In example 550 the minimum word edit distance is 2, resulting from 1) the addition 560 of the word “SO” and 2) a change 562 of the word “awrsome” to the word “awesome.” There could be other word edit distances such as 1) the addition of the word “SO” and 2) a removal of the word “awrsome,” and 3) the addition of the word “awesome.” However, other word edit distances have more additions, deletions, or changes than 2, meaning they are not the minimum edit word distance.

In example 550, the word edit distance threshold is set to two words. The minimum word edit distance between the language snippets is two, so, in example 550, process 500 continues on to character alignment, as directed by block 512.

In this example, process 500 can then set word pair 564 with the first addition, deletion, or change as the selected word pair, as shown a block 516. Since word pair 564 resulted from a word addition, aligning the characters 566 to characters 568, corresponding to block 518, results in all the characters being additions, so the minimum character edit distance is two. In example 550, the character edit distance threshold is 25%. At 570 of example 550, corresponding to block 520, word pair 564 is determined not to be a correction because the 100% minimum character distance is greater than the 25% character edit distance threshold.

In example 550, process 500 can then determine that there is one more with an addition, deletion, or change, so word pair 572 is set as the selected word pair, as shown at blocks 524 and 526. Aligning the characters 574 to characters 576, corresponding to block 518, results in one character change 578, so the minimum character edit distance is one. There are seven characters 574 of the original word, so that minimum character edit distance percentage is 14%. In example 550, the character edit distance threshold is 25%. At 580 of example 550 corresponding to block 520, word pair 572 is determined to be a qualified correction because the 14% minimum character distance is less than the 25% character edit distance threshold. A data structure can then be updated to include word pair correction 572, corresponding to block 522.

In example 550, process 500 then determines that there were no additional word pairs with additions, deletions, or corrections between words 556 and 558, corresponding to block 524. In example 550, process 500 also determines that there were no additional language snippet pairs between received language snippets 552 and 554, corresponding to block 528. The identified word pair correction 572 can then be returned, corresponding to block 532. This example of process 500 would then end at block 534.

FIG. 6 is a flow diagram 600 illustrating a process used in some implementations for modifying a language snippet using correction replacements. Process 600 begins at block 602. At block 604 a language snippet can be received. The received language snippet can be taken from a text, audio, image, or video source. In various implementations, the received language snippet can be from a content item, such as a social media post, that is to be converted into an intermediate version for a machine translation, a query entered through a search field where a corrected version is searched instead of or in addition to the actual search query, or as a user entered text that needs to have suggested corrections or automatic corrections identified.

At block 606 the received language snippet can be split to identify various n-grams. In some implementations, the identified n-grams can be all possible n-grams or all possible n-grams at or below a specified length, such as four words. The n-grams do not have to be mutually exclusive, i.e. words from one n-gram can appear in another n-gram. For example, for the language snippet “I'm going home,” the n-grams can be “I'm,” “going,” “home,” “I'm going,” “going home,” and “I'm going home.” In some implementations, the n-grams can be limited to either one word or a specified length, corresponding to one plus the length of the context specified for word pairs in an applied correction module. For example, if a correction module has specified a two-word context, then all single word n-grams and three word n-grams will be selected. For example, for the language snippet “I'm going home,” the n-grams can be “I'm,” “going,” “home,” and “I'm going home.”

At block 608 the first n-gram identified at block 606 is set as a selected n-gram. In some implementations, prior to setting the selected n-gram, the n-grams resulting from block 606 can be sorted by number of words, shortest to longest. This permits the remainder of process 600 to first match single word corrections that do not require a context, such as where an unknown word is being replaced, then make context based corrections. For example, a given language snippet “Let's walj the god,” where the context length is 3, could be divided into the n-grams “Let's,” “walj,” “the,” “god,” and “Let's walj the god.” By first correcting “walj” to “walk” it is more likely that a context matching “Let's walk the” will be found for the word pair “god”->“dog,” so this second correction can also be found.

At decision block 610 process 600 determines whether the selected n-gram has a word length of one. If so, this means that the word can be corrected if it is an unknown word and context may not be considered. This analysis proceeds at block 612. If the selected n-gram has a word length greater than one, this means that the word can be corrected even if it is a known word, based on its context. This analysis proceeds at block 618.

At decision block 612 process 600 determines whether the selected n-gram matches a known word. In some implementations, this can be language independent. In some implementations, a language can be determined for the language snippet received at block 604 and the comparison for a known word for the selected n-gram can be limited to that determined language. If the selected n-gram matches a known word it will not be replaced and process 600 continues to block 620. If the selected n-gram does not match a known word it can be replaced and process 600 continues to block 614.

At decision block 614 process 600 determines whether an applied correction module includes a word pair correction matching the selected n-gram. In some implementations, this can include a non-exact match. For example, if a word pair correction was found as “spexial”->“special” the corrected character can be replaced with a wild card character so any n-gram matching “spe_ial” will be replaced with “special.” Alternatively, certain likely letters can be used to make a correction, such as the keys on a standard keyboard surrounding the corrected letter or using a similar type of letter such as vowel replacement. For example, the correction “spexial”->“special” can be abstracted as “spe[x, z, a, s, d]ial”->“special.” As another example the correction “cag”->“cog” can be abstracted as “c[a, e, i, u]g”->“cog.” In some implementations, the degree of matching for a replacement to occur can be application specific. For example, an exact match can be needed when doing an automatic correction, whereas less than exact matches can result in a replacement when creating an intermediate language snippet for a machine translation or for augmenting query search results. If the applied correction module includes a word pair correction matching the selected n-gram process 600 continues to block 616, otherwise process 600 continues to block 620.

At block 616 the replacement, comprising of a word pair correction, found at block 614 is used to replace the selected n-gram with the replacement portion of the word pair correction. In some implementations, when a replacement is performed, the replacement of the selected n-gram is also made within all the other n-grams created at block 606, as discussed above in relation to the “Let's walj the god” example.

At block 620 process 600 determines whether there are additional n-grams that were identified at block 606 and that have not been analyzed by the loop between blocks 610-620. If there are additional n-grams process 600 continues to block 622, where the next one of these n-grams can be set as the selected n-gram to be operated on by the loop between blocks 610-620. If there are no additional n-grams process 600 continues to block 624.

If, at block 610, process 600 determines that the selected n-gram has a word length greater than one it will have continued to block 618. At decision block 618 process 600 determines whether an applied correction module has a replacement for the selected n-gram. At decision block 618 the selected n-gram will have a length greater than one, so a replacement will comprise a word pair correction and a corresponding context. For example, if the selected n-gram is “Let's take my bar,” and an applied correction module has a word correction pair of “bar”->“car” with a context-before comprising “Let's take my,” then this can be a matching replacement to change “bar” to “car.” In some implementations, the matching does not have to be an exact match. Similarly to block 614, the matching of a word in the n-gram to an original word of a word pair correction does not have to be an exact match. Furthermore, non-exact matches can be found in context words as well. This can be single letter changes within particular words, or entire word changes. In some implementations, similar words or word types can be used to match a context to the selected n-gram. For example, if the selected n-gram is “You got a new jab!” and an applied correction module has a correction word pair of “jab”->“job,” a context matching “You got a new” can use word abstractions and equivalents. Word abstractions can classify a word as a type or use a list of often used replacements such as identifying “You” as a word which is often replaced with an identification of another entity such as “I” or “your,” or “my” word abstractions can also identify some words as less important such as “a,” or “new.” Using word equivalents can identify alternate words such as “have” or “land” for “got,” or can apply different word ending and tenses. Using this type of non-exact matching, the selected n-gram “You got a new jab!” can be matched with a word pair correction “jab”->“job” with a context “I landed a.” Similarly to block 614, the level of matching needed to find a match can be application specific.

In addition, as discussed above in relation to context identification module 348, contexts other than surrounding words can be used to determine a match. For example, a word pair can be associated with a geographic location or an author age. A replacement identification at block 614 or 618 can be made where the language snippet received at block 604 is associated with a sufficiently similar geographic location or author age. As a more specific example, a received language snippet can be “Hey bro!” which is associated with a context of author age=65. An applied correction module can have the word pair correction “bro”->“now” associated with a context of authors over the age of 24, which would result in the correction “Hey now!” If a replacement is not found at block 618 process 600 continues to block 620; and if a replacement is found, process 600 continues to block 616.

At block 616, coming from block 618, the selected n-gram is updated to replace, with the update word from the word pair correction, the word in the selected n-gram matching the original word of the word pair correction. As discussed above, in some implementations, this change can be propagated to all the n-grams found in block 606.

Process 600 then continues to block 620, discussed above. At decision block 620, once all the identified n-grams from block 606 have been operated on by the loop between blocks 610-620, process 600 continues to block 624. At block 624 the modified language snippet can be returned. Process 600 then continues to block 626, where it ends.

Several implementations of the disclosed technology are described above in reference to the figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links may be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word “or” refers to a union of all possible permutations of a set of items (i.e. “and/or”). For example, the phrase “A, B, or C” refers to any of A; B; C; A and B; A and C; B and C; A, B, and C; or multiple of any item such as A and A; B, B, and C; or A, A, B, C, and C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above, are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for generating a natural language correction module, comprising:
receiving one or more sets of language snippets, each received set of language snippets comprising a sequence of an initial language snippet and one or more updates to either the initial language snippet or a previous language snippet in the sequence;
for at least one selected set of the one or more sets of language snippets, identifying at least one qualified correction by:
computing that a minimum word edit distance between at least two of the language snippets of the selected set is below a word difference threshold;
creating word pairs by aligning words between the at least two of the language snippets of the selected set according to the minimum word edit distance; and
identifying qualified corrections as the created word pairs that have a minimum character edit distance that is below a character difference threshold; and
incorporating the identified qualified corrections into the natural language correction module.

2. The method of claim 1 further comprising, for at least one identified set of the one or more sets of language snippets, computing that the identified set does not include any qualified correction by computing:
that a word edit distance between the language snippets of the identified set is above a word difference threshold; or
that a word edit distance between the language snippets of the identified set is below the word difference threshold and that each character edit distance of word pairs, matched by aligning words according to a minimum character edit distance between the language snippets of the identified set, is above a character difference threshold.

3. The method of claim 1 wherein at least one set of the one or more sets of language snippets comprises:
a post to a social media website, by an author, as the initial language snippet; and
one or more sequential updates, by the author, to the post to the social media website as the updates to the previous language snippet in the sequence.

4. The method of claim 1 wherein each minimum word edit distance is computed by determining a minimum number of word additions, word removals, or word substitutions required to transform (A) a first of the at least two of the language snippets of the selected set into (B) a second of the at least two of the language snippets of the selected set.

5. The method of claim 4 wherein the computation of at least one of the minimum word edit distances is further based on a comparison of (a) the number of word additions, word removals, or word substitutions to (b) a word count of one or more of the language snippets of the selected set.

6. The method of claim 1 wherein each minimum character edit distance is computed by determining a minimum number of character additions, character removals, or character substitutions required to transform (A) a first word of that word pair into (B) a second word of that word pair.

7. The method of claim 1 wherein one or more of the qualified corrections includes a correction to punctuation.

8. The method of claim 1 wherein computing each minimum word edit distance and computing each minimum character edit distance is independent of punctuation.

9. The method of claim 1 further comprising
determining that the correction type for a chosen one of the qualified corrections is equivalent to real-word to real-word correction; and
in response to the determining, correlating a context with the chosen one of the qualified corrections.

10. The method of claim 9 wherein the context is, at least in part, an n-gram appearing before or after the chosen one of the qualified corrections.

11. The method of claim 9 wherein the context comprises one or more identifications of a characteristic associated with one or more of the language snippets from the selected set that produced the chosen one of the qualified corrections, wherein the one or more identifications of a characteristic comprise one or more of:
an identification of other content items or links;
an internet location where one or more of the language snippets from the selected set is posted or used; or
a geographic location associated with one or more of the language snippets from the selected set.

12. The method of claim 9 wherein the context comprises one or more identifications of a characteristic associated with an author of one or more of the language snippets from the selected set that produced the chosen one of the qualified corrections, wherein the one or more identifications of a characteristic comprise one or more of:
a location associated with the author;
an author age;
an author gender;
an author ethnicity;
an author profession;
an author income; or
an friend group identified for the author.

13. The method of claim 1 wherein the natural language correction module is configured to use the identified qualified corrections as part of a machine translation of a provided language snippet by:
creating an intermediate version of the provided language snippet by:
matching one or more unknown words in the provided language snippet to a word corresponding to a first word of one or more of the qualified corrections; and
replacing each of the unknown words with a second word from the qualified correction that includes the first word matched to that unknown word;
performing a machine translation on the intermediate version; and
providing results of the machine translation on the intermediate version.

14. A computer-readable storage medium storing instructions that, when executed by a computing system, cause the computing system to perform operations for generating a natural language correction module, the operations comprising:
receiving one or more sets of language snippets, each received set of language snippets comprising a sequence of an initial language snippet and one or more updates to either the initial language snippet or a previous language snippet in the sequence;
for at least one selected set of the one or more sets of language snippets:
identifying at least one qualified correction based on a comparison of character edit distances between:
at least one word in an earlier language snippet of the sequence of language snippets of the selected set; and
at least one word in an later language snippet of the sequence of language snippets of the selected set; and
providing an indication of the identified at least one qualified correction.

15. The computer-readable storage medium of claim 14 wherein identifying the at least one qualified correction is performed by:
determining that a word edit distance between at least two of the language snippets of the selected set is below a word edit difference threshold;
creating word pairs by aligning words between the at least two of the language snippets of the selected set according to the minimum word edit distance; and
performing the comparison of character edit distances between the created word pairs;
wherein each identified qualified correction is one of the created word pairs that has a minimum character edit distance that is below a character edit difference threshold.

16. The computer-readable storage medium of claim 15 wherein each minimum word edit distance is computed by determining a minimum number of word additions, word removals, or word substitutions required to transform (A) a first of the at least two of the language snippets of the selected set into (B) a second of the at least two of the language snippets of the selected set.

17. The computer-readable storage medium of claim 14 wherein the operations further comprise, for at least one selected qualified correction of the qualified corrections:
extracting an n-gram from one of the language snippets which originated a word of the selected qualified correction, wherein the n-gram appears before or after the word of the selected qualified correction; and
correlating the n-gram with the selected qualified correction.

18. The computer-readable storage medium of claim 14 wherein at least one set. of the one or more sets of language snippets comprises:
a post to a social media website, by an author, as the initial language snippet; and
one or more sequential updates, by the author, to the post to the social media website as the updates to the previous language snippet in the sequence.

19. A system for generating a natural language correction module, comprising:
a memory;
one or more processors;
an interface configured to receive one or more sets of language snippets, each received set of language snippets comprising either the initial language snippet or a sequence of an initial language snippet and one or more updates to a previous language snippet in the sequence;
a word edit distance module configured to:
for at least one selected set of the one or more sets of language snippets, compute a minimum word edit distance between at least two of the language snippets of the selected set;
identify which of the sets of language snippets has a computed minimum word edit distance below a word difference threshold; and
create word pairs by aligning words between the at least two of the language snippets of the sets of language snippets identified as having a minimum word edit distance below the word difference threshold;
a character edit distance module configured to:
identify qualified corrections as the word pairs, of the word pairs created by the word edit distance module, that have a minimum character edit distance that is below a character difference threshold; and
a correction module builder configured to incorporate the qualified corrections identified by the character edit distance module into the natural language correction module.

20. The system of claim 19 further comprising a context identification module configured to:
determine that a correction type for a chosen one of the qualified corrections, identified by the character edit distance module, is equivalent to real-word to real-word correction; and
in response to the determining, correlate with the chosen one of the qualified corrections a context of the correction;
wherein the context is, at least in part, an n-gram appearing before or after the chosen one of the qualified corrections in at least one of the one or more language snippets of the identified set that produced the chosen one of the qualified corrections.
